(19) United States
(12) Patent Application Publication
(10) Pub. No.: US 2020/0125593 A1
(43) Pub. Date: Apr. 23, 2020

(54) Method and System for Notation of Messages Stored on a Mobile Device

(71) Applicant: Oliver Wendel Gamble, New York, NY (US)

(72) Inventor: Oliver Wendel Gamble, New York, NY (US)

(21) Appl. No.: 16/718,124

(22) Filed: Dec. 17, 2019

Related U.S. Application Data
(63) Continuation-in-part of application No. 14/541,132, filed on Nov. 13, 2014.

(51) Int. Cl. G06F 16/335; G06F 3/0481; G06F 3/0484; G06F 16/22; G06F 16/338

(52) U.S. Cl. CPC G06F 16/335; G06F 3/0481; H04W 4/12; G06F 16/2282; G06F 16/338; G06F 3/0484

(57) ABSTRACT

A messaging system with methods for adding descriptive notes to Emails and Text Messages store on a mobile device. Enabling the user of the mobile device to enhance the value of content of messages stored on the mobile device. The ability to annotate messages when they are first encountered will enable the user to increase the relevant of a message when it is viewed at a later date. By being able to add information to the text message that may have been conveyed to the user by methods other than the Email or Text messages that is being notated.

The present application claims the benefit of priority of patent application Ser. No. 14/541,132 entitled “ Method and System For Interactive Notation on a Mobile Device,” filed on Nov. 13, 2013, the disclosure of which is hereby incorporated by reference in its entirety for all purposes.

Before the present methods and systems are disclosed and described in this patent, it is to be understood that the methods and systems are not limited to specific methods, specific components, or to particular implementations. It is also to be understood that the terminology used herein is for the purpose of describing particular embodiments only and is not intended to be limiting to the scope of the patent.

### FIELD OF THE INVENTION

The present invention relates generally to a method and system for improving the ability to understand information contained in an email or text message sent or received on a mobile device. Traditional email and texting messages contain information that is stored in a mobile device until it is reviewed. If sufficient time has passed since receiving or sending of said message there may be a lack of clear memory of the message's significant. The more messages that are accumulated and more time that passes the dimmer one's memory can become on the facts or import of a piece of information sitting on a mobile device.

What is needed is a method for storing additional information about a message that is stored on a person's mobile device. The ability to customize the notation on a message, not just add a flag to indicate importance of a message.

### BACKGROUND OF THE INVENTION

It so often happens that you receive a piece of information that has a lot of significant to something, that you forget over time and interactions with the process of life. It would be nice if we could Annotate messages with information that we think is important to a received or sent message.

The ability to annotate will enable mobile device users add notation to their received and send email and text message communicates. This ability will increase the value of saved message, by making them more relevant to the user, by allowing the user to see all of the notes that were and references that originally believed to be significant to the mobile device user.

### SUMMARY OF THE INVENTION

Accordingly, an improved system and method is desirable for annotating messages stored on a mobile device. To achieve this goal, each received and sent email and text messages is stored in a record in a table in a database. The messages are parse into various fields in the record. The record in the table has fields for all of the elements of the received or sent message and a few extra fields. One of these extra fields it labelled Annotation, and it will hold a large block of text. The Annotation field is accessible by the user and allows the user to type in any sort message (a word, a string of words, or a large paragraph). The Annotation of each record/messages can be called up and viewed with the press of a button when the user is viewing a message.

### Preferred Embodiment

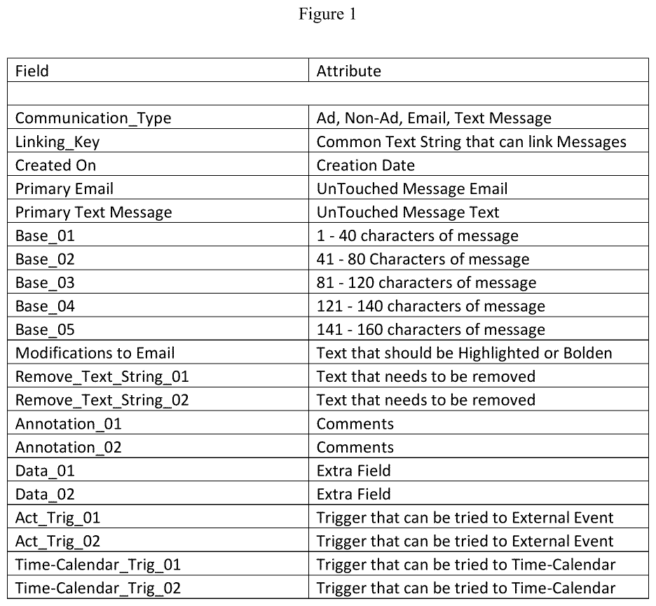

An application that is loaded on to/into a mobile device contains a database, that contains tables, that are composed of records. Each record contains a variety of fields similar to that of FIG. 1. Once the application is installed, each sent and received email and text message will be stored in fields of an individual record. The contents of fields are both searchable and editable. The user of the application can access and enter information into the field denoted as “Annotation_01” or “Annotation_02” (see FIG. 1). When an email is sent or received it is converted into a string and stored in the “Primary Email” field of the record. The record is stored in a table that is viewable by the user, allowing the user to view all sent and received emails in various orders (i.e. by sender, by date, by sender and date, by subject, by sender and subject, and by date and subject and by sender). When a text message is sent or received it is converted into a string and stored in the “Primary Text Message” field of the record. The record is stored in a table that is viewable by the user, allowing the user to view all received and sent text message in various orders (i.e. by sender, by date, by sender and date, by receiver, and by receiver and date). While viewing a stored message (email or text message), the user can click on a button to access a text box that stores whatever is written in it to the first annotation field (“Annotation_01”). When they have finish entering notes the user presses an indication to signal finish and the contents are saved and the text box is closed. Because the messages are stored as records in a database format of searchable fields in a table, it is possible for the use to search the table for specific message(s), or to display the search results for messages in a specific order.

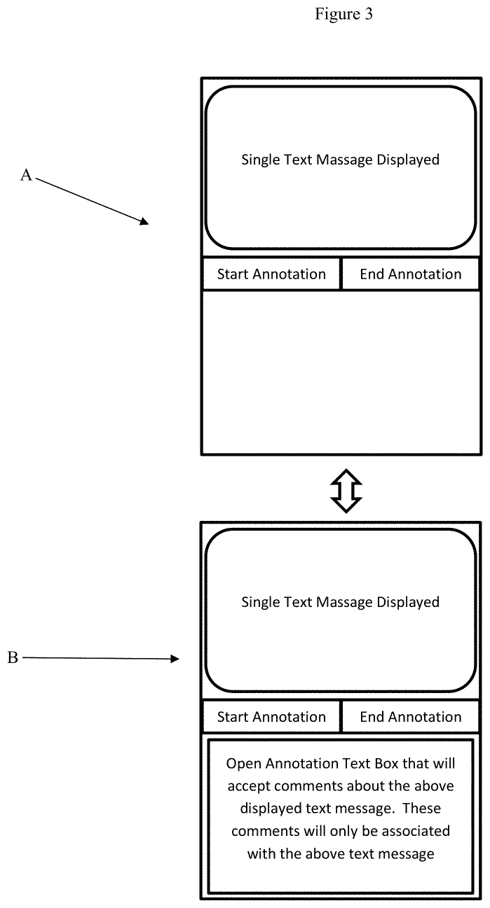

In FIG. 3 has two components. The components are labelled “A” and “B”. In component “A” we see a representation of a mobile device screen with a display area for a message content of either an email or a text message to be viewed. The message content can be either a sent or received message of an email or text message. Under the message display area is two buttons, one for starting the “Annotation process” and the other for ending the “Annotation process”. When the mobile device user presses the “Start Annotation” button, a text box will one on the screen. The user will be able type in any message they want regarding the message. This message will be stored in the “Annotation_01” field of the record.

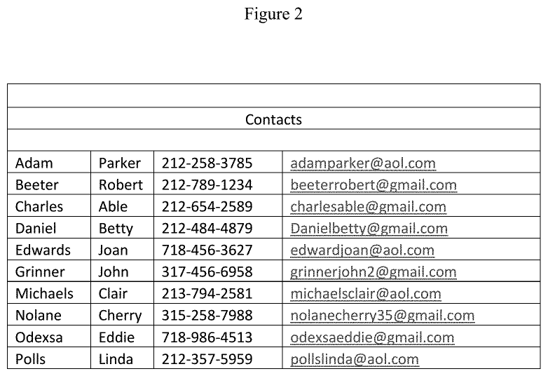

In one embodiment, the text message and email can be displayed in either mixed together or separated by type: email & text message. It would be possible to display email and text messages mixed together by allowing the text messages to look up the name and email of the sender and store it in a field of the record, or allow the email to look up the phone number of the party the mail is addressed to using the mobile device contact database and store that information into a field in the table (i.e. the “Linking_Key” field). FIG. 2 is representative of the Contact list in a mobile device. It contains the name, phone number and email address of the contacts. The Application would take an email sender's address and look it up in the Contact list, and if found the Application would take the associated phone number and place it in the “Linking_Key” field. This process will allow all email to be able to be associated with the text messages that come from the same location. The reverse can be done for text messages, where the Contact list is used to look up phone numbers to be placed in the “Linking_Key” field of received emails.

In an alternative embodiment, the “Communication_Type” field can be used to allow the mobile device user to search, view, and annotation only email or only text message at time. The user can user the “Communication_Type” field to selectively search, view, and annotate only email messages stored in records in the table; or only search, view, and annotate only text messages stored in the records in a table: Emails vs Text Messages.

FIG. 1 is a prototype listing of fields of a record that is used to store individual sent and received emails and text messages.

FIG. 2 is representative of the Contact list in a mobile device.

FIG. 3 is a representation of a text message with Annotation.

1. A method for enriching the value of a message stored on a mobile device comprising:
software on a mobile device storing individual sent and received messages in fields of a record in table of a database; storing each of the messages in a record that contains multiple fields, and said record's fields being accessible to the mobile device user for searching, editing, and displaying a stored message; stored messages on said mobile device can be viewed and the contents of said fields in the record can be edited by the user of the mobile device user; the contents of a designated user editable field can be stored and viewed by the user of the mobile device at the same time said user is viewing the contents of a sent or received message also store in said record.

2. The method of claim 1, wherein the messages stored on the mobile device can be emails or text messages.

3. The method of claim 2, wherein some of the fields will contain components of the sent or received message, and others will be initially set aside as blank fields that will be designated editable fields.

4. The method of claim 3, wherein the once content has been entered into a formerly blank designated editable field it will be saved within the record.

5. The method of claim 4, wherein when a stored message is viewed on a mobile device the user can activate the display of the contents stored in the previously designated editable field alongside of the stored message.

6. The method of claim 1, wherein stored messages are searchable by the user and the results of the searched for message will be displayed on the mobile device enabling the user to co-display the contents stored in the editable field alongside of the stored message.

7. A method for storing and later reviewing information related to a sent or received message comprising: software to store both received and sent emails and text messages and any additional notation that the user might want to consider when reading each of the messages that are stored in field of a record in a table in a database.

8. The method of claim 7, wherein each message and entered notation are store in fields of that same record and can be viewed at the same time.

9. The method of claim 8, wherein stored messages can be either a sent or received email or text message.

10. The method of claim 9, wherein the messages are stored in searchable, editable, displayable fields of a record in a table in a database.

11. The method of claim 7, wherein the user can search the table of stored messages and once located and displayed can further improve their understanding of the message by reviewing additional notes regarding the message that is also stored on the mobile device.

12. The method of claim 7, wherein the user can search the table of stored messages and once located and displayed can further improve their understanding of the message by reviewing additional notes regarding the message that is also stored on the mobile device.

13. The method of claim 11, wherein the messages are stored in searchable, editable, displayable fields of a record in a table in a database.

14. A method for storing and display supplemental information relating to a message stored on a mobile device comprising: software on a mobile device for storing individual sent and received messages in fields of a record in table of a database.

15. The method of claim 14, wherein specific fields in a table are set aside for storing the contents-information that is contained in a message and other fields are set aside for storing notes related to a said message.

16. The method of claim 15, wherein each message stored in its own record is contained multiple fields and said record's fields are accessible to the mobile device user for searching, editing, and displaying stored message.

17. The method of claim 14, wherein each message stored in its own record is contained multiple fields and said record's fields are accessible to the mobile device user for searching, editing, and displaying stored message.

18. The method of claim 14, wherein the user can search the table of stored messages and once located and displayed can further improve their understanding of the message by reviewing additional notes regarding the message that is also stored on the mobile device.
